(19) United States
(12) Patent Application Publication
(10) Pub. No.: US 2020/0352684 A1
(43) Pub. Date: Nov. 12, 2020

(54) Denture Attachment

(71) Applicant: Denflex Co., LTD, Seoul (KR)

(72) Inventor: Hyung-Woo KIM, Gyeonggi-do (KR)

(73) Assignee: Denflex Co., LTD, Soeul (KR)

(21) Appl. No.: 16/832,813

(22) Filed: Mar. 27, 2020

Related U.S. Application Data
(63) Continuation of application No. PCT/KR2020/002673, filed on Feb. 25, 2020.

(30) Foreign Application Priority Data
May 9, 2019 (KR) 10-2019-0054434
Feb. 14, 2020 (KR) 10-2020-0018301

(51) Int. Cl. A61C 8/00

(52) U.S. Cl. CPC A61C 8/0068; A61C 8/0095; A61C 8/0074; A61C 8/0057

(57) ABSTRACT

A denture attachment is provided. More particularly, a denture attachment is such that a user can detachably fasten a first fastening part coupled to a denture to a second fastening part placed on top of a natural tooth's root or implant fixture by a simple operation, and furthermore, even when occlusal force is continuously applied to the denture, the applied force can be buffered by an elastic rib structure of the attachment itself. Consequently, it is possible to extend not only the lifespan of the attachment, but also the lifespan of the implant fixture or natural tooth's root, and to provide superior performance with a significantly smaller volume than existing attachments, while providing excellent durability.

### CROSS-REFERENCE TO EARLIER FILED APPLICATIONS

The present application is a continuation of and claims the benefit of PCT/KR2020/002673 filed Feb. 25, 2020, which claims the benefit of foreign application KR 10-2019-0054434 filed May 9, 2019 and KR 10-2020-0018301 filed Feb. 14, 2020, the entire disclosures of which are hereby incorporated by reference.

### FIELD OF THE INVENTION

The present invention relates generally to a denture attachment. More particularly, the present invention relates to a denture attachment, wherein a user can detachably fasten a first fastening part coupled to a denture to a second fastening part placed on top of a natural tooth's root or implant fixture by a simple operation, and furthermore, even when occlusal force is continuously applied to the denture, the applied force can be buffered by an elastic rib structure of the attachment itself. Consequently, it is possible to extend not only lifespan of the attachment, but also lifespan of the implant fixture or natural tooth's root, and to provide superior performance with a significantly smaller volume than existing attachments, while providing excellent durability.

### BACKGROUND OF THE INVENTION

Dentures are a type of a tooth replacement prosthetic for damaged permanent teeth, and are widely used because they have less economic burden than artificial dental implants. Dentures are removable devices that can be fitted to a user's gums. For example, dentures can be removed from the gums at night for cleaning or sleeping, and can be fitted to the gums during the day for eating or going out.

In general, retention of dentures is reinforced by denture attachments. In a conventional denture attachment, there is provided a structure in which a second fastening part placed on the top of a fixture implanted in an alveolar bone of a human body and a first fastening part embedded in the bottom of a denture are detachably coupled to each other. In this structure, generally, the second fastening part is made of metal, the first fastening part embedded in the bottom of the denture is configured with a polymer such as plastic or rubber ring placed in a narrow space in a metal housing, and the coupling of the first and second fastening parts is implemented by means of elastic force of a plastic or rubber ring.

However, in this conventional denture attachment, due to the fact that the second fastening part made of metal and placed on one side of the fixture, and the first fastening part in which an elastic body made of plastic or rubber is placed in the narrow space in the metal housing embedded in the bottom of the denture are detachably coupled to each other, there is a problem in that wear of the plastic or rubber may occur as the denture use time increases, and stress may be continuously applied to the attachment as the position of the denture continues to change due to occlusal forces in various directions applied to the denture, leading to a reduction in durability such as damage to the polymer e.g. plastic or rubber.

There is another problem in that as the denture use time increases, wearability and stability of the denture may be lowered, such as the denture not being firmly secured to the gum and shaking when the denture is worn, due to wear of the plastic or rubber ring in the metal housing of the first fastening part.

Furthermore, in the conventional denture attachment, due to the fact that the plastic or rubber of a very small size in the metal housing of the first fastening part has a material limitation in exerting a cushioning function that can be exerted within an elastic deformation limit, masticatory force generated when chewing food while wearing the denture may be transmitted directly from the denture to the fixture, and at this time, the masticatory force may be concentrated on the fixture, leading to a problem that the attachment or fixture may be deformed and damaged, and due thereto, frequent maintenance of the attachment may be required, leading to a problem of inconvenience and excessive maintenance costs.

In particular, in general, when the occlusal force is applied to the denture, a gum area which is in contact with the bottom of the denture may be contracted under pressure, and consequently, there often occurs a case in which the position of the denture placed on the gum may be also displaced toward the gum by the degree of contraction. As described above, when the occlusal force is continuously applied to the denture and the denture is continuously displaced toward the gum, there is a problem in that the masticatory force may intensively transmit excessive force to the attachment or the fixture, thereby shortening lifespan of the denture.

Therefore, there is a need for a denture attachment that allows the user to attach or detach a denture by simple operation, and that, even when masticatory or occlusal force is continuously applied to the denture, can buffer the transmitted force by structural features of the attachment itself.

Furthermore, the conventional attachment is a type that utilizes elasticity of a polymer by mounting a non-metallic polymer such as plastic or rubber ring in the narrow space in the metal housing embedded in the bottom of the denture, and due to the limitation of the material, this type of attachment may be difficult to obtain sufficient elasticity and durability for mounting and dismounting of the denture and require more space to obtain more than a certain amount of elasticity and durability, and thus a metal housing with a larger volume may be required. In this case, however, when this metal housing is embedded in the bottom of the denture, in many cases, there is a problem in that the metal housing may protrude to the buccal or lingual side of the denture. Accordingly, there is a need for an attachment having as small a volume as possible while having sufficient elastic retention and durability.

Another problem of the conventional attachment is that when a plurality of fixtures is implanted in the alveolar bone, a corresponding part is placed on the top of each of the plurality of fixtures, and a plurality of fastening parts corresponding thereto is embedded in the bottom of the denture, i.e., when a plurality of attachments is used, If the fixtures implanted in the alveolar bone are not parallel but are inclined to each other by an angle of placement of equal to or greater than 20 degree angles, a straight-type corresponding part generally used may not be used as the corresponding part placed on the top of the fixture due to the limitation of the angle at which each attachment can be fastened, and thus it is cumbersome to compensate for a large difference in the angle of placement by using a special corresponding part called an angled abutment. Moreover, even if such a special corresponding part called an angled abutment is used, there is a problem in that it may be impossible to produce a variety of angled abutment for all angles to compensate for all angles of placement. Accordingly, there is a need for a denture attachment that can use a single corresponding part even if the fixtures differ greatly in the angle of placement.

In a hook coupling method as another conventional technique, the distance from a flange portion embedded in the bottom of a denture to the gum may be too short, and due thereto, with the use of a short hook protrusion formed by a simple straight incision toward the gum from the flange portion embedded in the bottom of the denture, it may be impossible to obtain sufficiently soft and proper elastic force, durability, and proper denture retention required for repeated mounting and dismounting of a denture. This may cause a denture attachment to rapidly lose elastic force in a short time due to repeated mounting and dismounting of the denture. Furthermore, due to occlusal force in various directions continuously applied to the denture while the denture is mounted in the oral cavity, a stress break function that elastically buffers the movement of the denture in all directions, including front and rear, left and right, cannot be exerted. Therefore, there is a problem in that the short hook protrusion may be highly likely to suffer permanent deformation, and that lifespan of a fixture may be shortened due to continuous impact of unbuffered occlusal force.

### SUMMARY OF THE INVENTION

Accordingly, the present invention has been made keeping in mind the above problems occurring in the related art, and an objective of the present invention is to provide a denture attachment, wherein a user can detachably fasten a first fastening part coupled to a denture to a second fastening part provided on top of a natural tooth's root or implant fixture by a simple operation, and furthermore, even when occlusal force is continuously applied to the denture, the applied force can be buffered by an elastic rib structure of the attachment itself, thereby making it possible to extend not only lifespan of the attachment, but also lifespan of the implant fixture or natural tooth's root.

Another objective of the present invention is to provide a denture attachment, wherein by configuring the attachment itself to have a buffer function by a plurality of elastic ribs having a helical shape, stress applied by occlusal force can be buffered and not concentrated on the attachment or implant fixture, and furthermore, stress caused by vertical and lateral pressure can be buffered.

Still another objective of the present invention is to provide a denture attachment having a small volume while having sufficient retention, durability, and elasticity.

Still another object of the present invention is to provide a denture attachment, wherein even when angles of placement of a plurality of fixtures implanted in an alveolar bone differ greatly, it is not necessary to use a separate angled second fastening part.

In order to accomplish the above objective, according to one aspect of the present invention, there is provided a denture attachment that is used to reinforce retention of a denture placed into an oral cavity, the denture attachment including: a first fastening part coupled to the denture; and a second fastening part provided on top of a root of a natural tooth buried in an alveolar bone or top an implant fixture implanted in the alveolar bone, and coupled to the first fastening part, wherein at least one of the first fastening part and the second fastening part may include a plurality of elastic ribs having a helical shape that is formed in a predetermined section, and provided along an outer circumference thereof about an inner diameter central axis A, the respective unit elastic ribs may be configured such that one ends thereof are connected to each other and the other ends are separated from each other, and the other ends form elastic fastening portions deformed inwardly or outwardly with respect to the inner diameter central axis A upon application of external force and restored to an original shape thereof upon removal of elastic force, and by an elastic restoring action of the elastic ribs, the first fastening part and the second fastening part may be elastically coupled to or separated from each other.

Preferably, the plurality of elastic ribs may be configured such that the helical shape is formed in the predetermined section and a straight shape is formed at an end portion.

More preferably, the denture attachment may further include an elastic rib protective housing provided on an outer peripheral surface of the plurality of elastic ribs having the helical shape.

Preferably, the elastic rib protective housing may corrugations formed circumferentially so that the elastic rib protective housing may be collapsed and shortened in a predetermined section.

More preferably, an inner diameter formed by the end portion of the plurality of elastic ribs having the helical shape may be less than a maximum outer diameter of a part that is fastened correspondingly to the end portion.

Even more preferably, an inner diameter of the elastic fastening portions formed by the plurality of elastic ribs having the helical shape may be changed according to vertical position.

Most preferably, when the first fastening part and the second fastening part are coupled to each other, a space B for accommodating vertical position changes of the denture may be formed between a lower plane of an axial hole of the first fastening part, the axial hole being defined in the plurality of elastic ribs by being surrounded thereby, and an upper end of the second fastening part.

According to the present invention, a user can detachably fasten a first fastening part coupled to a denture to a second fastening part placed on top of a natural tooth's root or implant fixture by a simple operation, and furthermore, even when occlusal force is continuously applied to the denture, the applied force can be buffered by an elastic rib structure of the attachment itself. Consequently, there is provided an effect of extending not only lifespan of an attachment, but also lifespan of the implant fixture or natural tooth's root. Furthermore, by configuring the attachment itself to have a buffer function by a plurality of elastic ribs having a helical shape, stress applied by occlusal force can be buffered and not concentrated on the attachment or implant fixture, and furthermore, stress caused by vertical and lateral pressure can be buffered and distributed uniformly.

Furthermore, according to the present invention, at least one of the second fastening part placed on one side of a fixture and the first fastening part embedded in the bottom of the denture includes elastic fastening portions comprised of a plurality of elastic ribs having a helical shape formed in a predetermined section, and an open end portion of the elastic ribs in which a helical shape is formed in the predetermined section has an elastic fastening force by elastic movement inwardly or outwardly with respect to the inner diameter center axis A of the elastic ribs, whereby it is possible to increase the length of the elastic ribs by at least equal to or greater than 2.5 times longer than when the elastic ribs are formed in a straight shape to have a fastening force, thereby greatly increasing the amount of elastic deformation without causing permanent deformation of the helical elastic ribs. Consequently, the attachment can have an increased elastic durability and can exhibit a soft detachable force. The attachment can also exert a stress break function that can allow a predetermined amount of denture movement in all directions, including front, rear, left, and right, which may occur when occlusal forces in various directions are applied to the denture, thereby providing an effect of extending lifespan of the fixture or attachment.

Furthermore, in a denture attachment having a very short vertical length, due to a sufficient elastic force obtained due to a spiral shape, the first fastening part and the second fastening part of the attachment can be configured with metal without a polymer. Therefore, there is provided an effect of reducing the volume of the attachment and realizing a semi-permanent attachment that has excellent wear resistance and durability.

Furthermore, due to the increase in the amount of elastic deformation that can be restored without permanent deformation, when a portion correspondingly coupled to the elastic fastening portions is formed in a spherical or hemispherical shape, even if the angle of placement between the fixtures is greater than 45°, the portion and the elastic fastening portions can be detachably coupled to each other without the use of a separate angled second fastening part.

### BRIEF DESCRIPTION OF THE DRAWINGS

FIG. 1A is an exploded perspective view illustrating a denture attachment according to an embodiment of the present invention, and FIG. 1B is an exploded perspective view illustrating a denture attachment according to another embodiment of the present invention.

FIG. 2A is an assembled perspective view illustrating the denture attachment according to the embodiment of the present invention, and FIG. 2B is an assembled sectional view illustrating the denture attachment according to the embodiment of the present invention.

FIG. 3 is an exploded perspective view illustrating a denture attachment according to another embodiment of the present invention.

FIG. 4A is an assembled perspective view illustrating the denture attachment according to the embodiment of the present invention, and FIG. 4B is an assembled sectional view illustrating the denture attachment according to the embodiment of the present invention.

FIG. 5A is a perspective view illustrating an embodiment of a first fastening part according to the present invention, and FIG. 5B is a perspective view illustrating another embodiment of a first fastening part according to the present invention.

FIG. 6 is a perspective view illustrating a structure of a second fastening part according to another embodiment of the present invention.

FIG. 7 is a sectional view illustrating a structure of a second fastening part according to another embodiment of the present invention and a structure of a first fastening part coupled to the second fastening part.

FIG. 8 is a sectional view illustrating another embodiment of an elastic rib protection housing for protecting elastic ribs according to the embodiment of the present invention.

FIG. 9 is a perspective view illustrating a structure of a second fastening part according to another embodiment of the present invention.

FIG. 10A illustrates a first fastening form in which a first fastening part is coupled to the second fastening part illustrated in FIG. 9, and FIG. 10B illustrates a second fastening form in which the first fastening part is coupled to the second fastening part illustrated in FIG. 9.

FIG. 11 is a sectional view illustrating a “space for accommodating vertical position changes of a denture” in another embodiment of the present invention.

### DETAILED DESCRIPTION OF THE INVENTION

Hereinafter, exemplary embodiments of the present invention will be described in more detail with reference to the accompanying drawings.

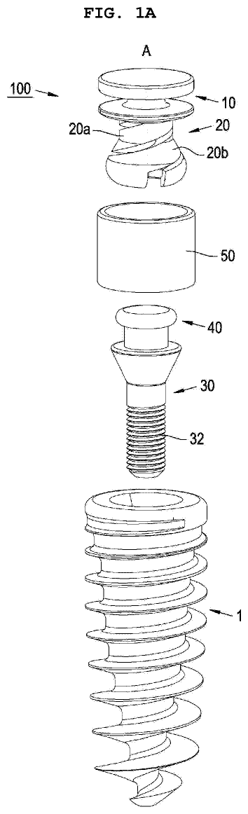

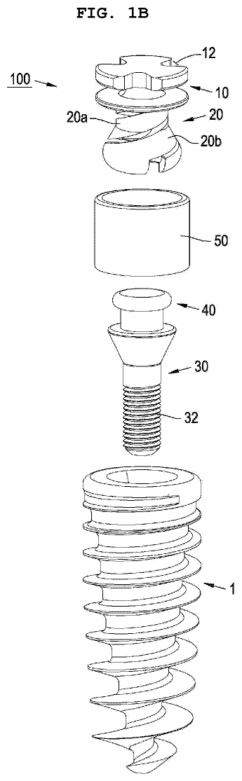

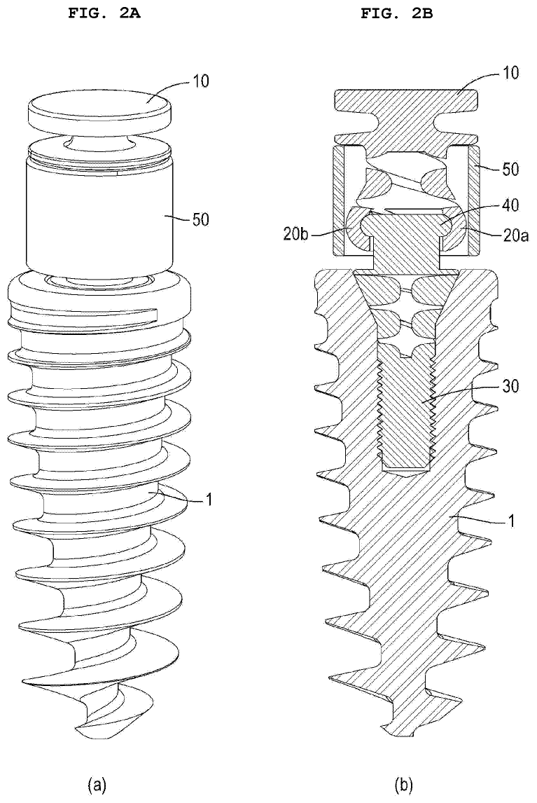

FIG. 1A is an exploded perspective view illustrating a denture attachment according to an embodiment of the present invention, and FIG. 1B is an exploded perspective view illustrating a denture attachment according to another embodiment of the present invention. FIG. 2A is an assembled perspective view illustrating the denture attachment according to the embodiment of the present invention, and FIG. 2B is an assembled sectional view illustrating the denture attachment according to the embodiment of the present invention.

First, an denture attachment 100 according to an embodiment of the present invention illustrated in FIGS. 1A, 1B, 2A, and 2B is used to reinforce retention of a denture placed in an oral cavity, and includes: a base part 10 coupled to the bottom of the denture that comes into contact with a gum; a first fastening part 20 extending downwardly from the base part 10, and including a plurality of elastic ribs 20a and 20b protruding downwardly along an outer circumference thereof; and a second fastening part 40 provided on top of a root of a natural tooth buried in an alveolar bone or top of an implant fixture 1 implanted in the alveolar bone, and coupled to the first fastening part 20. In FIGS. 1A and 1B, it is illustrated that an abutment 30 provided with the second fastening part 40 is coupled to the top of the implant fixture 1. However, the second fastening part 40 may be provided on the top of the natural tooth's root or implant fixture by using various methods. Alternatively, the second fastening part 40 may be integrally formed with the implant fixture implanted in the alveolar bone.

The base part 10 is fixed to the bottom of the denture with an adhesive resin or the like. It would be apparent that the base part 10 may be manufactured in various shapes and forms, as long as being capable of functioning to be fixed to the denture. As illustrated in FIG. 1B, the base part 10 includes a recess 12 recessed inwardly from at least one portion of an outer surface thereof. Preferably, the recess 12 may be provided as three curved recesses, and it would be apparent that various numbers and shapes of recesses may be provided. The adhesive resin used to fix the attachment to the bottom of the denture is also charged into the recesses 12 so as to reinforce adhesive strength of the resin and to impart a rotation preventing function.

As illustrated in FIGS. 1A, 1B, 2, and 3, the first fastening part 20 extends downwardly from the base part 10, and includes the plurality of elastic ribs 20a and 20b having a helical shape that is formed in a predetermined section, and protruding downwardly along the outer circumference of the first fastening part 20 with respect to the same inner diameter central axis A. Preferably, the respective unit elastic ribs 20a and 20b may be configured such that one ends thereof are connected to each other and the other ends are separated from each other, and the other ends may form elastic fastening portions deformed inwardly or outwardly with respect to the same inner diameter central axis A upon application of external force and restored to an original shape thereof upon removal of elastic force, and by an elastic restoring action of the elastic ribs, the first fastening part 20 and the second fastening part 40 can be elastically coupled to or separated from each other.

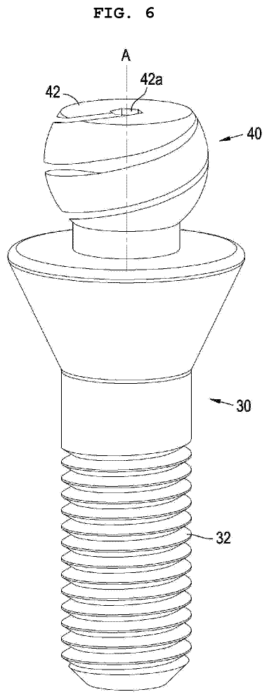

Meanwhile, as illustrated in FIG. 6, the second fastening part 40 may also include a plurality of elastic ribs having a helical shape and provided along an outer circumference thereof with respect to the same inner diameter central axis A. That is, at least one of the first fastening part 20 and the second fastening part 40 may include a plurality of elastic ribs having a helical shape that is formed in a predetermined section, and provided along the outer circumference thereof with respect to the same inner diameter central axis A.

Referring to FIG. 1A, the abutment 30 is fastened to the top of the root of the natural tooth buried in the alveolar bone or the top of the implant fixture 1 implanted in the alveolar bone, with an upper portion provided with the second fastening part 40 detachably coupled to the first fastening part 20. That is, threads 32 of the abutment 30 are screwed and fixed into an axial hole of the implant fixture 1.

Referring to FIG. 2B, the abutment 30 is screwed to the implant fixture 1, the second fastening part 40 protruding from the upper portion of the abutment 30 is fastened into a first fastening hole, i.e., a fastening space that is defined in the plurality of elastic ribs 20a and 20b by being surrounded thereby. That is, a user may place the first fastening part 20, extending from the base part 10 fixed to the denture by the adhesive resin, correspondingly onto the top of the second fastening part 40, and in this state, the user may simply press the entire denture downwardly to cause the first fastening part 20 to be fastened to the second fastening part 40, whereby the denture can be efficiently mounted on the gum with a clicking sound. Here, when the first fastening part 20 comprised of the plurality of elastic ribs 20a and 20b is fastened to the second fastening part 40, the plurality of elastic ribs 20a and 20b is elastically fastened to the second fastening part 40 by the elastic restoring action by which the elastic ribs 20a and 20b are deformed outwardly or inwardly with respect to the same inner diameter central axis A and then restored to an original shape thereof upon completion of fastening. In some cases, the second fastening part 40 may be integrally formed with the implant fixture 1.

Referring to FIGS. 1A and 1B, due to the fact that the first fastening part 20 is comprised of the plurality of elastic ribs 20a and 20b each of which has a helical shape formed over the predetermined section, the plurality of elastic ribs 20a and 20b having such a helical shape itself has a buffer function so as to buffer stress applied by occlusal force, as well as to disperse stress caused by vertical and lateral pressure.

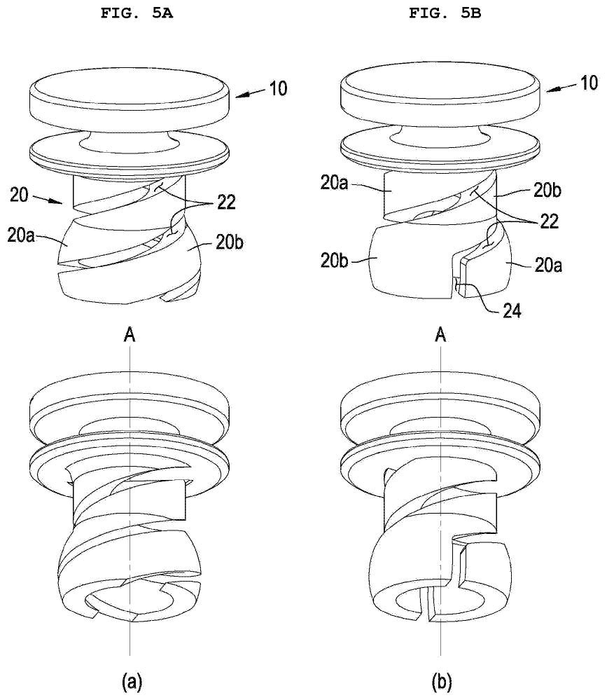

FIG. 5A is a perspective view illustrating an embodiment of a first fastening part according to the present invention, and FIG. 5B is a perspective view illustrating another embodiment of a first fastening part according to the present invention. Preferably, as illustrated in FIG. 5A, a plurality of elastic ribs 20a and 20b may have a helical shape formed in the entire section including a lower end of the first fastening part 20. In this case, a helical gap 22 is formed between neighboring elastic ribs 20a and 20b. Most preferably, as illustrated in FIG. 5B, a plurality of elastic ribs 20a and 20b may be configured such that a helical shape is formed in a predetermined section and a straight shape is formed at an end portion. In this case, a helical gap 22 is formed between upper neighboring elastic ribs 20a and 20b, and a vertical gap 24 is formed in a predetermined section of the end portion. As such, the reason why the vertical gap 24 is formed in at the end portion which is open is to secure sufficient mechanical strength of the elastic ribs 20a and 20b. This takes into account that if the elastic ribs 20a and 20b have a helical shape formed from the base part 10 to the lower end of the first fastening part 20 as illustrated in FIG. 5A, particularly the mechanical strength of the edge of an open portion may be lowered. However, it should be construed that the present invention include all structures in which the plurality of elastic ribs 20a and 20b may have a helical shape in at least a predetermined section of the first fastening part 20.

Referring to FIGS. 1A and 1B, the present invention may further include an elastic rib protective housing 50 provided on an outer peripheral surface of the plurality of elastic ribs 20a and 20b. The elastic rib protective housing 50 is to prevent the adhesive resin or the like used to fix the base part 10 to the bottom of the denture from penetrating between the elastic ribs 20a and 20b of the first fastening part 20. The elastic rib protective housing 50 may be provided integrally with the base part 10. Alternatively, the elastic rib protective housing 50 may be manufactured in a detachable form so that the elastic rib protective housing 50 can be removed after the operation of fixing the base part 10 is completed. Preferably, the elastic rib protective housing 50 may be manufactured to have a gap that is defined between an inner surface of the elastic rib protective housing 50 and an outer surface of the first fastening part 20 by a space for allowing deformation so that when the first fastening part is fastened to the second fastening part 40 or when occlusal force is applied to the denture, a space in which the elastic ribs 20a and 20b can be deformed in the elastic rib protective housing 50.

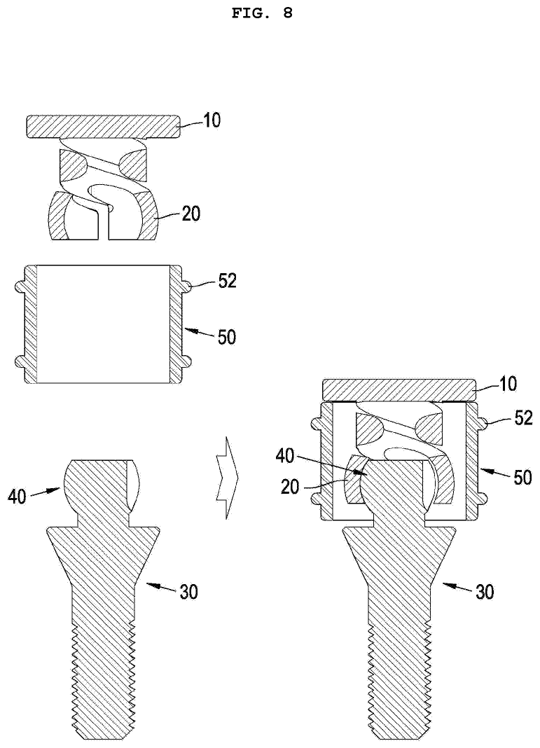

According to another embodiment of the present invention, as illustrated in FIG. 8, an uneven portion 52 may be further provided on an outer circumferential surface of the elastic rib protective housing 50. This is to ensure that when both the base part 10 and the elastic rib protective housing 50 are embedded into the denture by resin or the like, the uneven portion 52 is combined with the resin, thereby securing robustness and durability. Preferably, the elastic rib protective housing 50 may have corrugations formed circumferentially so that the elastic rib protective housing 50 can be collapsed and shortened in a predetermined section in a vertical length direction. In some cases, the elastic rib protective housing 50 may be made of a synthetic resin material such as a polymer to facilitate a corrugation process.

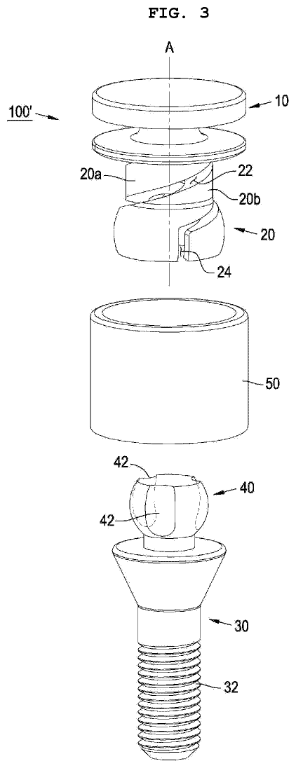

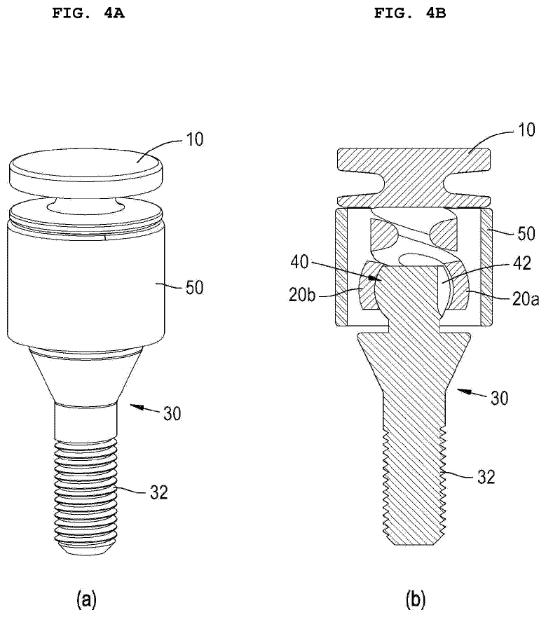

FIG. 3 is an exploded perspective view illustrating a denture attachment according to another embodiment of the present invention, FIG. 4A is an assembled perspective view illustrating the denture attachment according to the embodiment of the present invention, and FIG. 4B is an assembled sectional view illustrating the denture attachment according to the embodiment of the present invention.

Referring to FIGS. 3 and 4B, a second fastening part 40 is formed to protrude upwardly from an upper surface of an abutment 30, and is elastically detachably fastened into a first fastening hole that is defined in the a plurality of elastic ribs 20a and 20b by being surrounded thereby. More preferably, a groove 42 for fit with a driver is formed in an outer surface of the protruding second fastening part 40 at each angle of 120 degrees or 180 degrees so that the respective grooves are radially arranged with respect to a vertical central axis of the second fastening part. Therefore, when an operator rotates the abutment 30 with the driver fitted in the grooves 42, the abutment 30 may be efficiently fastened to the implant fixture 1. Meanwhile, as illustrated in FIG. 6, a groove into which a wrench, for example, can be fitted may be formed in the second fastening part 40 in various shapes, such as a hexagonal groove.

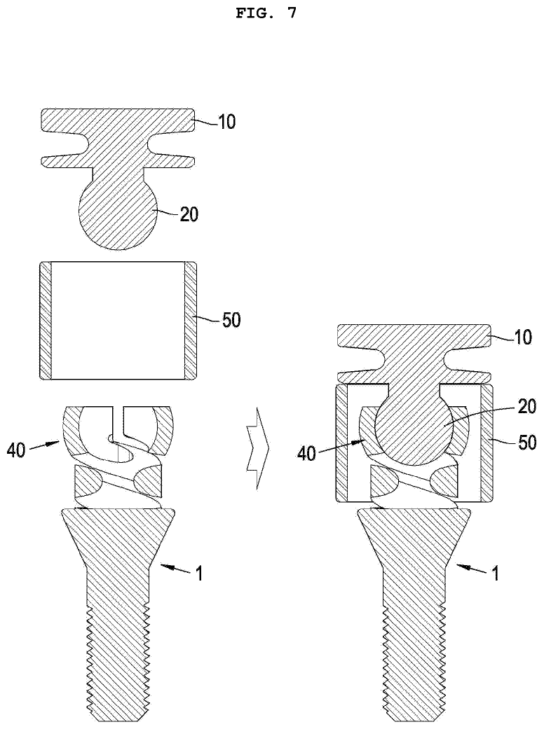

According to another embodiment of the present invention, as illustrated in FIG. 7, there may be provided a structure in which a first fastening part 20 is fastened to a second fastening part 40 comprised of a plurality of elastic ribs. In this case, when the first fastening part 20 is fitted into and fastened to the second fastening part 40, the plurality of elastic ribs is elastically fastened to the first fastening part 20 by an elastic restoring action by which the elastic ribs are deformed outwardly with respect to the central axis A and then restored to an original shape thereof upon completion of fastening.

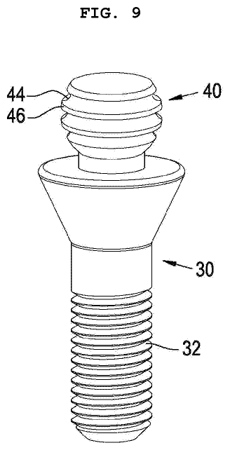

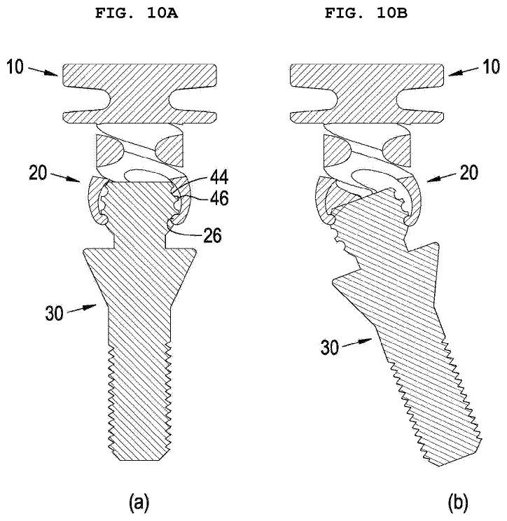

Referring to FIGS. 9 and 10, a plurality of annular grooves 44 and protrusions 46 may be circumferentially formed on an outer surface of a second fastening part 40 and arranged in a vertical direction, and annular protrusions 26 corresponding to the annular grooves may be formed on an inner surface of the elastic ribs of the first fastening part 20. Preferably, when two annular grooves and two protrusions are formed on the outer surface of the second fastening part, a lower one of the annular grooves and a lower one of the protrusions are formed larger in diameters than an upper one of the annular grooves and the upper one of the protrusions, respectively.

Conventionally, when a plurality of implant fixtures is implanted into the alveolar bone and an attachment is inserted into the bottom of the denture at a position corresponding to each of the fixtures so that the respective attachments can be fastened to the placed fixtures, when angles formed by meeting of vertical central axes of the plurality of placed fixtures are too large, there is a problem in that existing attachments may be unable to use because angles at which they can be fastened to the fixtures are limited to small angles. However, according to the above-described fastening structure of the present invention, when the angles formed by the meeting of the vertical central axes of the implant fixtures are only within 45 degree angles, the denture can be fastened to the fixtures without any problems.

That is, when the angles formed by the meeting of the vertical central axes of the plurality of implant fixtures implanted in the alveolar bone is greater than 25 degree angles, it is often impossible for many existing attachments to be coupled to the bottom of the denture and used. However, according to the above-described fastening structure of the present invention, even when the angles formed by the meeting of the vertical central axes of the plurality of placed implant fixtures is greater than 25 degree angles, the first fastening part can be fastened to the second fastening part so as to be inclined with respect to the vertical central axis of the second fastening part. Therefore, it is possible to solve the above problems, while maintaining fastening force.

For example, referring to FIG. 10B, when one of the plurality of implant fixtures implanted in the alveolar bone is inclined to the alveolar bone at an angle of equal to or greater than 25 degrees, the denture can be fastened to the implant fixtures without using a separate angled abutment.

In this case, it is preferable to form a plurality of annular grooves such that the distance (see FIG. 10A) between the protrusions of the first fastening part when the protrusions are fastened to an annular groove having the same vertical position, and the distance between the protrusions of the first fastening part when the protrusions are fastened to annular grooves having different vertical positions are equal to each other.

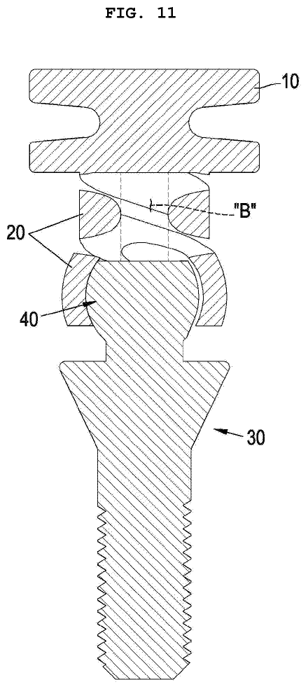

FIG. 11 is a sectional view illustrating a “space for accommodating vertical position changes of a denture” in another embodiment of the present invention. Referring to FIG. 11, when the first fastening part 20 and the second fastening part 40 are fastened together, the “space B for accommodating vertical position changes of the denture” may be formed between a lower plane of the axial hole of the first fastening part 20, the axial hole being defined in the plurality of elastic ribs by being surrounded thereby, and an upper end of the second fastening part 40. Preferably, the vertical height of the space B may be at least equal to or greater than 0.6 mm.

When occlusal force is applied to the denture and the gum in contact with the bottom of the denture is pressurized thereby, causing a change in vertical position of the denture, the first fastening part (i.e., the plurality of elastic ribs) surrounding the second fastening part 40 is deformed outwardly, causing the second fastening part 40 to be moved to the “space B for accommodating vertical position changes of the denture”. Subsequently, when the occlusal force is removed and the pressurized gum is restored thereby, the first fastening part 20 is restored to an original position thereof, whereby the second fastening part 40 can be elastically restored in the axial hole of the first fastening part 20 to a vertical position before application of the occlusal force.

While the specific embodiments of the invention have been described above in detail with reference to the drawings, the present invention should not be limited to specific structures of the embodiments. Those skilled in the art will appreciate that various modifications, additions and substitutions are possible, without departing from the scope and spirit of the invention as disclosed in the accompanying claims. However, all of the simply modified or changed structures may be clearly included within the scope of rights of the present invention.

1. A denture attachment that is used to reinforce retention of a denture placed into an oral cavity, the denture attachment comprising:
a first fastening part coupled to the denture; and
a second fastening part provided on top of a root of a natural tooth buried in an alveolar bone or top an implant fixture implanted in the alveolar bone, and coupled to the first fastening part,
wherein at least one of the first fastening part and the second fastening part includes a plurality of elastic ribs having a helical shape that is formed in a predetermined section, and provided along an outer circumference thereof about an inner diameter central axis (A),
the respective unit elastic ribs are configured such that one ends thereof are connected to each other and the other ends are separated from each other, and the other ends form elastic fastening portions deformed inwardly or outwardly with respect to the inner diameter central axis (A) upon application of external force and restored to an original shape thereof upon removal of elastic force, and
by an elastic restoring action of the elastic ribs, the first fastening part and the second fastening part can be elastically coupled to or separated from each other.

2. The denture attachment of claim 1, wherein the plurality of elastic ribs is configured such that the helical shape is formed in the predetermined section and a straight shape is formed at an end portion.

3. The denture attachment of claim 1, further comprising:
an elastic rib protective housing provided on an outer peripheral surface of the plurality of elastic ribs having the helical shape.

4. The denture attachment of claim 3, wherein the elastic rib protective housing has corrugations formed circumferentially so that the elastic rib protective housing can be collapsed and shortened in a predetermined section.

5. The denture attachment of claim 1, wherein an inner diameter formed by the end portion of the plurality of elastic ribs having the helical shape is less than a maximum outer diameter of a part that is fastened correspondingly to the end portion.

6. The denture attachment of claim 1, wherein an inner diameter of the elastic fastening portions formed by the plurality of elastic ribs having the helical shape is changed according to vertical position.

7. The denture attachment of claim 1, wherein when the first fastening part and the second fastening part are coupled to each other, a space (B) for accommodating vertical position changes of the denture is formed between a lower plane of an axial hole of the first fastening part, the axial hole being defined in the plurality of elastic ribs by being surrounded thereby, and an upper end of the second fastening part.

8. A denture attachment that is used to reinforce retention of a denture placed into an oral cavity, the denture attachment comprising:
a first fastening part coupled to the denture; and
a second fastening part provided on top of a root of a natural tooth buried in an alveolar bone or top an implant fixture implanted in the alveolar bone, and coupled to the first fastening part,
wherein at least one of the first fastening part and the second fastening part includes a plurality of elastic ribs having a helical shape that is formed in a predetermined section, and provided along an outer circumference thereof about an inner diameter central axis (A), wherein the plurality of elastic ribs is configured such that the helical shape is formed in the predetermined section and a straight shape is formed at an end portion,
the respective unit elastic ribs are configured such that one ends thereof are connected to each other and the other ends are separated from each other, and the other ends form elastic fastening portions deformed inwardly or outwardly with respect to the inner diameter central axis (A) upon application of external force and restored to an original shape thereof upon removal of elastic force, and
by an elastic restoring action of the elastic ribs, the first fastening part and the second fastening part can be elastically coupled to or separated from each other;
said denture attachment further comprising an elastic rib protective housing provided on an outer peripheral surface of the plurality of elastic ribs having the helical shape.

9. The denture attachment of claim 8, wherein the elastic rib protective housing has corrugations formed circumferentially so that the elastic rib protective housing can be collapsed and shortened in a predetermined section.

10. The denture attachment of claim 8, wherein an inner diameter formed by the end portion of the plurality of elastic ribs having the helical shape is less than a maximum outer diameter of a part that is fastened correspondingly to the end portion.

11. The denture attachment of claim 8, wherein an inner diameter of the elastic fastening portions formed by the plurality of elastic ribs having the helical shape is changed according to vertical position.

12. The denture attachment of claim 8, wherein when the first fastening part and the second fastening part are coupled to each other, a space (B) for accommodating vertical position changes of the denture is formed between a lower plane of an axial hole of the first fastening part, the axial hole being defined in the plurality of elastic ribs by being surrounded thereby, and an upper end of the second fastening part.

13. A denture attachment that is used to reinforce retention of a denture placed into an oral cavity, the denture attachment comprising:
a first fastening part coupled to the denture; and
a second fastening part provided on top of a root of a natural tooth buried in an alveolar bone or top an implant fixture implanted in the alveolar bone, and coupled to the first fastening part,
wherein at least one of the first fastening part and the second fastening part includes a plurality of elastic ribs having a helical shape that is formed in a predetermined section, and provided along an outer circumference thereof about an inner diameter central axis (A),
the respective unit elastic ribs are configured such that one ends thereof are connected to each other and the other ends are separated from each other, and the other ends form elastic fastening portions deformed inwardly or outwardly with respect to the inner diameter central axis (A) upon application of external force and restored to an original shape thereof upon removal of elastic force,
by an elastic restoring action of the elastic ribs, the first fastening part and the second fastening part can be elastically coupled to or separated from each other, and
wherein when the first fastening part and the second fastening part are coupled to each other, a space (B) for accommodating vertical position changes of the denture is formed between a lower plane of an axial hole of the first fastening part, the axial hole being defined in the plurality of elastic ribs by being surrounded thereby, and an upper end of the second fastening part, and
the plurality of elastic ribs is configured such that the helical shape is formed in the predetermined section and a straight shape is formed at an end portion.

14. The denture attachment of claim 13, further comprising:
an elastic rib protective housing provided on an outer peripheral surface of the plurality of elastic ribs having the helical shape.

15. The denture attachment of claim 14, wherein the elastic rib protective housing has corrugations formed circumferentially so that the elastic rib protective housing can be collapsed and shortened in a predetermined section.

16. The denture attachment of claim 13, wherein an inner diameter formed by the end portion of the plurality of elastic ribs having the helical shape is less than a maximum outer diameter of a part that is fastened correspondingly to the end portion.

17. The denture attachment of claim 13, wherein an inner diameter of the elastic fastening portions formed by the plurality of elastic ribs having the helical shape is changed according to vertical position.
